(19) United States
(12) Patent Application Publication
(10) Pub. No.: US 2013/0273512 A1
(43) Pub. Date: Oct. 17, 2013

(54) Checkerboard Math/Dora's Grid Math

(71) Applicant: Peter Gregory Grain, Fort Gratiot, MI (US)

(72) Inventor: Peter Gregory Grain, Fort Gratiot, MI (US)

(21) Appl. No.: 13/446,642

(22) Filed: Apr. 13, 2012

(51) Int. Cl. G09B 19/02

(52) U.S. Cl. 434/191

(57) ABSTRACT

A mathematical teaching aid based on a grid system. There are multiple grid based modules meant to teach math concepts from preK thru college level math. There are modules for teaching how to count, addition, subtraction, multiplication, division, and fraction manipulation (addition, subtraction, multiplication, division, equivalencies and LCD.) The system provides a physical, and visual model of math and lends itself to self-discovery/self-assistance by the student. The system is attractive to the student because coloring by the student is a part of the learning process, so the student is having fun while learning. This system exceeds the criteria for an ideal math model. These criteria are discussed in the definitive article (Murata, Aki (2008) ‘Mathematics Teaching and Learning as a Mediating Process: The Case of Tape Diagrams’, Mathematical Thinking and Learning, 10:4, 374-406.) This system is easy to use, inexpensive, and puts the student on math learning auto-pilot.

### REFERENCES

U.S. Pat. No. 4,609,356
U.S. Pat. No. 5,219,289
U.S. Pat. No. 7,709,721
U.S. Pat. No. 6,336,274
U.S. Pat. No. 6,840,439
U.S. Pat. No. 5,171,018
U.S. Pat. No. 5,362,239

### BACKGROUND

1. Field of the Invention

The present invention relates to the field of mathematical teaching tools based on a grid. It can be used for teaching a variety of math concepts from preK thru college math. And more particularly, the present invention relates to using a grid to create a grid based math model that uses observation, symbolism (color, numerals, objects), calculation (counting squares, counting objects, and counting other symbols), and most importantly writing (recording numerals, objects, and symbols and coloring objects and symbols) to stimulate the use of, and exploit the power of the brain's left sided math center and thereby teach math. This invention assists in the teaching of mathematical skills including addition, subtraction, multiplication, division, fractions, slope, area under the curve and many other math concepts from the preK thru college levels. Two years ago I began wondering why I was always superior in math. I thought all the way back to my early childhood and discovered the reason. When I was 1½ years old I moved from an apartment to my first private home. On my bedroom floor was a pattern of checkerboards. I spent many hours, days, weeks and years on that floor. At a certain point my mother told me to begin counting the squares on the checkerboards. I counted those squares from left to right starting on the lowest row working my way to the top. I always began at the beginning and tried to count more than the time before. I started to write the numbers down on paper with a pencil and correlate with the checkerboard. I started writing when I could hold a pencil. I started with a tally and later numbers when I could write numbers. At a certain point thereafter I was given tracing paper and began tracing the Checkerboard grids and filling in the tracing. I believe they were 10×10 checkerboards because I recall reaching 100. Along the way I began noticing number families on the checkerboard. Such as the number family for 20 which is 4×5, 5×4, 10×2, 2×10, and 1×20. All are all equal to 20 when you count the squares. I began correlating equivalent fractions by looking at 4×4 and 3×3 squares and seeing that 4/16=¼, 8/16=½, ⅓= 3/9. ⅔= 6/9, etc. My intuitive understanding of fractions as well as division was enhanced by a very special activity my mother played repeatedly with my friends and I, from a very early age called “SHARING”, described below. By the time I reached 100, which was when I was near five years old, I knew how to add and subtract two digit numbers. I knew most of my multiplication tables through the tens. I understood the concept of area, and perimeter for rectangles, squares, and complex shapes. Fractions, and equivalent fractions, were intuitively obvious. Finding Least Common Denominators was a simple task. You can use checkerboards for calculus concepts!

I have researched math modeling and found the definitive article on the subject (Murata, Aki (2008) ‘Mathematics Teaching and Learning as a Mediating Process: The Case of Tape Diagrams’, Mathematical Thinking and Learning, 10:4, 374-406). The article examines how “a visual representation may mediate the mathematics teaching and learning process when it is used over time. The process is explicated using the Zone of Proximal Development (ZPD) Mathematical Learning Model (Murata & Fuson, 2006; Fuson & Murata, 2007), based on Vygotskiian sociocultural theory (1978, 1999) to highlight the connections between social experiences of the learner and his/her cognitive development. In analyzing the learning process, the model helps bring forward the role of the representations (in the social learning experience) in student learning (cognitive development).” In that article and as suggested by other educators, the Ideal math model for educational use should fulfill certain criteria. Very specific criteria are laid out and are as follows:
1) Uniformity throughout as many years as possible. The same model should be extendable from the first use through higher grade levels.
2) The model should be extendable to as many math concepts as possible.
3) The model should be universal across cultural divides. The model should have no language, ethnic, or racial bias.
4) The model should allow a rich self-assistance phase during the learning process. After the model has been taught by a capable expert, the student uses the model to develop a rule set during a self-assistance phase. The goal in modeling in any teaching endeavor is to create a model that requires a minimum of instruction, but leads to a rich and complete discovery of the rule set as the student explores the model without the assistance of the teacher.

I have remained superior in math and have created a math teaching tool in a series of teaching modules based on a grid pattern and the games I played on checkerboards as a toddler. I have researched the Common Core State Standards for Mathematics and I have developed modules to cover the common core. Checkerboard Math is a new math teaching tool based on a grid pattern that had not yet been fully exploited until now. Grids have been used to teach certain specific math concepts, but only now has a math teaching tool been created based solely on a grid pattern and then using the synergy between the human brain's immature math center, symbolism, language, and writing, in order to teach math concepts at the preK thru college level. This tool is uniform from preK through college. It is extendable to countless math concepts. It is universal across cultural divides. It allows a rich self-assistance phase with a minimum of instruction by the teacher. It is easy to use, only requiring writing instruments for use, or observation by the user in order to gain benefit.

2. Prior Art Description

It has been known for many years to use a background grid or matrix to mount, arrange, and display geometric shapes to teach mathematical concepts, spatial relationships and geometric concepts. Gilden et al U.S. Pat. No. 4,609,356 and a mathematical game named “Colorama”, sold publicly in this country by Otto Maier Verlag of Ravenburg, Germany, are representative of prior art devices. Patricia K Derr U.S. Pat. No. 5,219,289 used a grid background along with various colored components and subcomponents to teach mathematical concepts, spatial relationships and geometry. This is another representative of prior art devices.

My distinction over the prior art lies in the recognition of the intimate relationship between writing, Symbolism, and calculation in the brain. These three activities form the core of this Math teaching tool. This innovative math modeling allows for a minimum of teacher instruction, that results in a rich self-assistance phase. In addition, the self-assistance phase for any particular Checkerboard Math module teaches the math model of the succeeding module such that there is a minimum of teacher involvement in order to teach each successive module. It puts the student on learning auto-pilot. Another clear distinction over the prior art is the ease of use and inexpensive nature of this system, that allows for clearer, less confusing demonstration of math concepts, and more of them. Prior art has been confusing, as well as inaccurate in demonstrating certain math concepts. The instruction set for teacher and student in prior art is unnecessarily complex and confusing, limiting use and requiring teacher involvement every step of the way. The stage II self-assistance phase (in Murata's paper) is virtually non-existent with prior art due to unnecessary complexity. The opposite is the case with CB Math. The student spends the majority of time in self-assistance phase, the goal of all teaching tools. I am an example of the power of CB Math. The only instruction for me was learning to count and to “count the squares.” I was in self assistance phase from that time on. The mechanism of use, coloring and writing, leaves a lasting impression in the students mind. This math teaching tool exploits the synergy between arithmetic, symbolism, language and writing. This is a clear departure and improvement over prior art.

### BRIEF DESCRIPTION OF THE DRAWINGS

FIG. 1 is an image of module 1

FIG. 2 is an image of module 2A

FIG. 3 is an image of module 2B

FIG. 4 is an image of module 2C

FIG. 5 is an image of module 3

FIG. 6 is an image of module 4A

FIG. 7 is an image of module 4B

FIG. 8 is an image of module 4C

### BRIEF DESCRIPTION

Checkerboard Math is a series of math teaching modules that uses a grid to create a grid based math model by using observation, symbolism (color, numerals, objects), calculation (counting squares, counting objects, and counting other symbols), and most importantly writing (recording numerals, objects, and symbols and coloring objects and symbols) to stimulate the use of, and exploit the power of the brain's left sided math center and thereby teach math in children and adults. This stimulates the development of the immature math center of the brain. By creating math models early in life, a student is able to rely on the brain's math center and its models, rather than rote memory for learning and incorporating future math concepts. The result is a student much more capable of tackling and mastering advanced math concepts. This is a new teaching tool not fully exploited in the past. It is a teaching process and tool that teaches math indirectly by allowing the student to develop his or her own conclusions and rule sets. By following a set of instructions meant to teach the model, the student plays self-discover games with a grid pattern. All current and future modules will be based on a grid pattern as the foundation for teaching math concepts. There are eight modules currently, all based on a grid pattern:
1) Module 1—Counting 1 to 100
2) Module 2A—Addition and Subtraction of Positive and Negative Numbers
3) Module 2B—Addition and Subtraction of Positive and Negative Numbers—Lower Place Value
4) Module 2C—Addition and Subtraction of Positive and Negative Numbers—Higher Place Value
5) Module 3—Number Families—Multiplication—Area—Perimeter
6) Module 4A—Sharing, Fractions, and Division
7) Module 4B—Fractions and Least Common Denominator (LCD)
8) Module 4C—Multiplying and Dividing Fractions

CB Math is appropriate for all ages as more and more advanced modules are developed. It can be presented for use in non-electronic forms in varying sizes and materials and is meant to be observed and manually completed by the user with a writing and/or coloring instrument. The manual modules will be made in the usual and customary way to make and print a multi sheet notepad, or single sheets, using standard sizes that will vary depending on the user or the material to be printed on. This math teaching aid can be presented in an electronic form with logical circuits incorporating the instruction set and external input device, touch function and/or other input device interfacing the user.

### DESCRIPTION OF THE PREFERRED EMBODIMENTS

The goal of math education is to create a model for math such that the equation: X+3Y/4=⅕ is easily conceptualized by the average person. Many species are born with the ability to understand magnitude and order. An animal knows when it is out numbered, and very specific pecking orders exist. A mountain gorilla knows who is first, second, and last, without going to school, and they know this in a shorter time than it takes humans. However as a neurosurgeon I am aware of the immature math center humans are blessed with. Adjacent to our speech center, on the left side of the human brain, is an area where the mechanics of mathematics goes on. Strokes in that area result in what is called “Gerstmann's Syndrome.” Gerstmann's syndrome is a cognitive impairment that results from damage to a specific area of the brain—the left parietal lobe in the region of the angular gyrus. It may occur after a stroke or in association with damage to the parietal lobe. It is characterized by four primary symptoms: a writing disability (agraphia or dysgraphia), a lack of understanding of the rules for calculation or arithmetic (acalculia or dyscalculia), an inability to distinguish right from left (left right disorientation), and an inability to identify fingers (finger agnosia). The embodiment of Checkerboard Math is to create a math model that allows users to rely on our calculation center rather than rote memory for future math conceptualization. Grid structure and rectangular arrays are ubiquitous within the control systems of the brain. The rectangle its line segments and diagonals are the basic unit of all connections within the brain. You have a single neuron forming a point. You have a connection between two neurons forming a line. You have a connection between three, all connected to each other, forming a triangle. Next you have four, forming a prism, again all neurons connected to each other. And when you add the fifth neuron (a square pyramid), arrays in both two as well as three dimensions become richer, and the different connection possibilities increase an order of magnitude. The purpose of checkerboard math is to stimulate connections in the brain associated with calculation and representation in written symbols. The human brain is the only brain that can calculate and represent the results of calculation in written symbols. Our calculator is adjacent to the last known area of evolution in the human brain, our language center. The finger agnosia of Gerstmann's Syndrome is not by accident. Naming objects like your fingers, writing, reading, arithmetic, and language are intimately connected and are represented in the same area of the brain. The inability to name objects in general, accompanies the other 4 symptoms in the majority of Gerstmann patients, but is not always part of the syndrome. Obviously calculation is tied to language and represented in the same area because of known phenomena from strokes and damage. Our calculator or math center is adjacent to the most recent area of known proliferation of neurons in the human brain, our language center. It is logical that it is primed for proliferation and improvement as technology expands and the daily needs of humans require increased math fluency. Modeling math in a grid pattern as the basis of the model will naturally support the mandatory basic unit of all connections within the brain and the geometry of nature. And when that math model is then tied to writing and answering all calculations using the model, exploitation and stimulation of the synergy between arithmetic, symbolism, language, and writing and subsequent reinforcement and proliferation of the neuron connections in our immature math center has to occur. Immediately after birth the retinae begins grid mapping the visual field. A grid system of connections exists in the retina at birth. However clarity and focus are finalized in the few mos. after birth, as higher levels of grid mapping are added with larger values of N.N×N grids are a basic unit in the retina representing parts of the visual field. Additionally, existing grid systems are connected to each other in those first three mos., and the emotional connection to vision begins (facial recognition etc.). It is known that a grid pattern is the pattern that attracts newborns most easily. Darker reds and blues before three mos. Lighter non patterned images are most attractive to them thereafter.

The true embodiment of preferred use for this invention is:
1) Have a capable expert (the teacher), create for a user (the student), a grid model of math using checkerboard math modules, and use that checkerboard math teaching tool/model strictly and uniformly for ALL current and future math conceptualizations. Include with that model a teacher instruction set that requires as minimal as possible teacher involvement that then results in a rich self-assistance phase in ZPD (Zone of Proximal Development) as defined in Murata's article.
2) Support the known neurological connection between arithmetic, writing, and symbolism by embedding at the core of this teaching tool is the use of those three elements synergistically. That is what this math teaching tool does: A. Arithmetic—counting squares (a symbol), adding squares etc. B. Writing—recording numerals (symbols) and coloring (symbolization) C. Symbols—symbolization with numerals and color. All three elements are mandatory, necessary, and embedded as the core parts of this math teaching tool.

All modules in the current embodiment have at their core the above two intended and preferred uses for the demonstration of math concepts from preK to college level. All future embodiments by this inventor will have at their core the above two intended and preferred uses. The expectation would be that, with correct instruction and use of this math teaching tool, the common core skill set of addition, subtraction, multiplication, division, and fractions would allow the average user to be able to see the individual operations of, and understand the meaning of: X+3Y/4=⅕, without difficulty!

### DETAILED DESCRIPTION

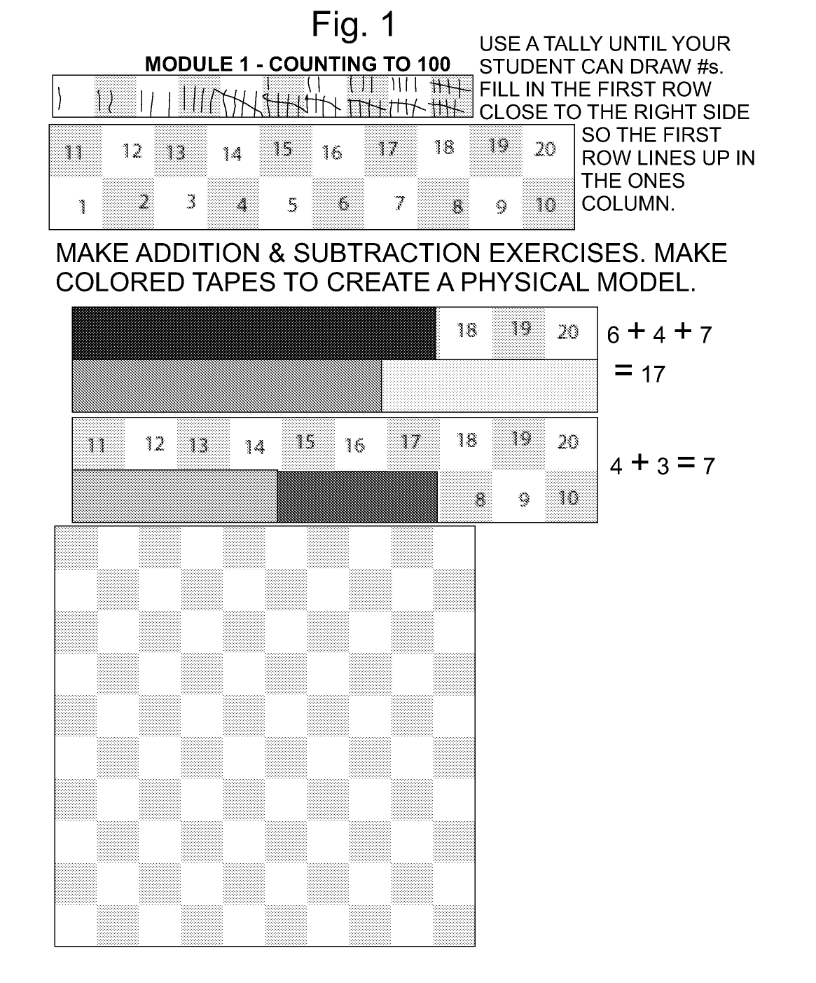

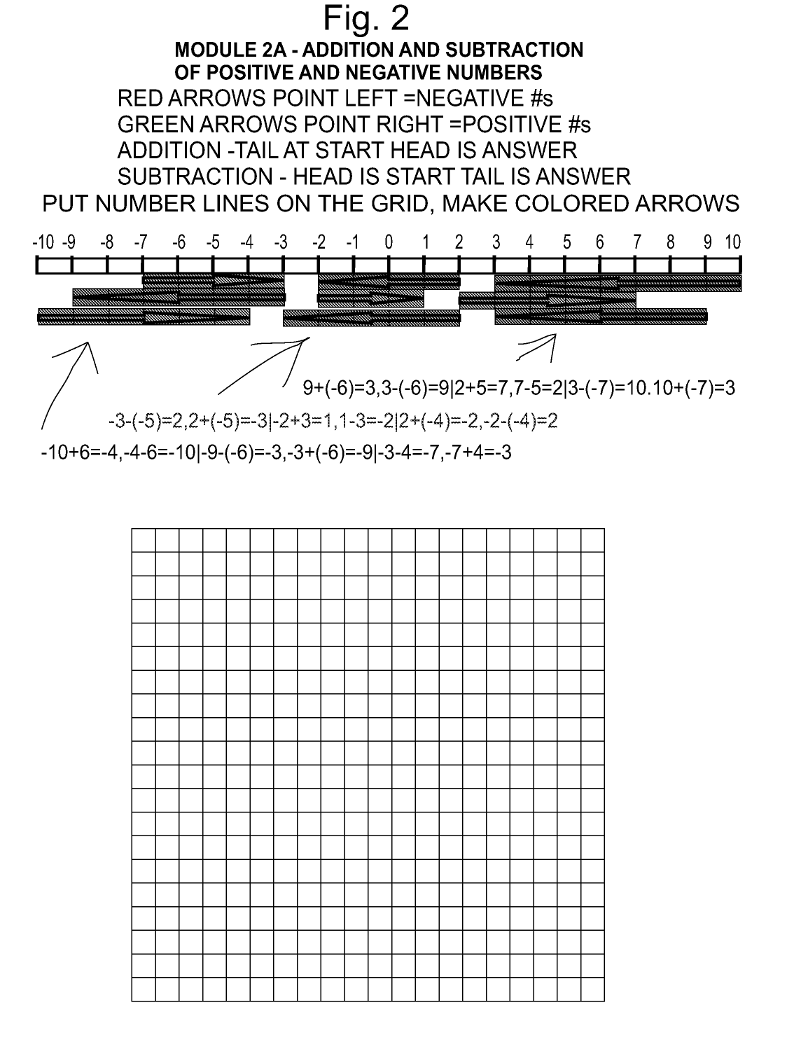

### Module 1—Counting 1 to 100 (FIG. 1)

Checkerboard Math use should begin at birth. The first three months of life is the time when visual spatial relationships in the human brain are most rapidly developing. Begin exposing your child to the grid pattern at that time. Create your own. Use imagination and resources you can download from CB Math to create exposure tools. Begin teaching your child how to count by counting the squares on module one starting at the lower left square and complete the row going to the right. Then start the second row with 11 in the leftmost square and complete that row. DO NOT ZIG-ZAG. Go left to right completing each row to 100. This is CRITICAL to the beginning success of this model. You will create math organization and help solidify the concept of tens by counting this way. Your child will get a sense of smaller and larger as the position of larger numbers rises. They will also get a sense of first and last. Use your finger and point to each square accurately. Get your child to do the same as soon as they are able. When your child begins filling in the grid they will see a pattern and create a rule set. Try to count to 100 for them as often as possible. You read to them don't you? Count to them! You will solidify a model they have been observing since birth. Fill in the checkerboard grid pattern with the numbers on the lowest row staying closer to the right border such that 1-9 lines up in the ones column. OVER TIME they will see a pattern. They will get a sense of place value for the tens place as they see the pattern of tens in each column. This will prepare them for mod2 A, B, and C. As you teach them to count emphasize two things with numbers, order and magnitude. Create red and green arrows as in module 2 to play games. Use the checkerboard pattern as often as possible to solidify the model, but they have their fingers and toes with them all the time. Let them count them. There are two things to emphasize as you teach your child to count to 100. You must help them to understand that numbers represent magnitude or quantity (five oranges, three apples, two ears), as well as order (Fifth Amendment, 3rd place, 1st in line.) As soon as your child can hold a pencil, have them fill in the checkerboard pattern in the way you have been counting to them. The ultimate goal is to get them to manually write the numbers 1 to 100 in one sitting on the corresponding squares of your 10 by 10 checkerboard. Create the challenge of accomplishing this by offering a reward to your student. Offer your child a reward whenever they can count more than the previous time. Always have your student begin at number one. The rule set for the model is developed best by REPETITION OVER TIME. Start a new CB Math Grid each school day. They must write row by row, from left to right as you were counting to them on the grid. Uniformity of the model is it's hallmark. Start at the lower left square. Complete that lowest row to 10 and then start the second row with 11 in the leftmost square and complete that row. Have your student work their way to the top ending at 100 in the upper right square. It may take an entire year to get to 10. That's fine. Use a tally if they can't write numbers. At a certain point, your child will zoom to 100. It will take them a year perhaps to go from 0 to 10, and OVER TIME they will go from 10 to 100. When your student is ready have them trace the checkerboard. Emphasize staying on the lines, Secure the tracing paper so it does not move, and give your student a straight edge to use when they are able. Do the sharing activity as often as possible. Your student will learn a number of mathematical concepts from that activity. Begin doing addition and subtraction exercises. Look at our addition and subtraction module and begin making the color coded directional arrow tools for use in this module. Encourage self-assistance and self-discovery, and OVER TIME your student will develop their own rule set. Notice the examples of addition exercises. Have your student create their own addition exercises, and remember that coloring the quantities used as shown will solidify the model. Introduce similar and simple subtraction exercises. Have your student create their own subtraction exercises. Coloring cannot be underemphasized.

### Module 2A—Addition and Subtraction of Positive and Negative Numbers (FIG. 2)

Use a combination of a number line centered on zero, and color coded directional arrows of varying magnitude. Positive quantities are always green arrows pointing right. Negative quantities are always red arrows pointing left. The arrows have gradations equal to the scale on the number line, and the number line has 0.0 on all numbers. Call it the number's tail when a kid asks, and tell them to not worry about it. Tell them we will lengthen the tail in the future. They need to see that place. To add we always place the arrow tail on the starting point and “Tape” the arrow down on the number line like taping with actual scotch tape. Do this in a fashion to give a sense of adding unit by unit ending at the answer. It is like filling a glass with water. The child gets a mechanical sense of addition that way. They see that adding a positive quantity moves you to the right, and adding a negative quantity moves you to the left on the number line. Subtraction is the opposite. You place the arrow head on the starting point. You allow the entire arrow to be on the number line, answer revealed at the tail. However, at that starting point you peel the arrow off the number line (like peeling off tape) in the direction of the tail and the student gets the mechanical sense of subtraction as they remove, take away, or “subtract” the arrow. They visually see that subtraction of a positive quantity moves you leftward on the number line as common sense tells you, but they also get a mechanical and visual representation of how subtraction of a negative quantity moves you rightward on the number line and increases your quantity. A concept that is hard for both children and adults to visualize and internalize. Remember: when you add a negative number you subtract and when you subtract a negative number you add! Give your student problems and have them use color coded directional arrows for solutions. Interject time (5 on Monday, 7 on Wednesday. etc.) Your student can also make labeled arrows from the bottom 6 number lines and also they can color the lines during their exploration.

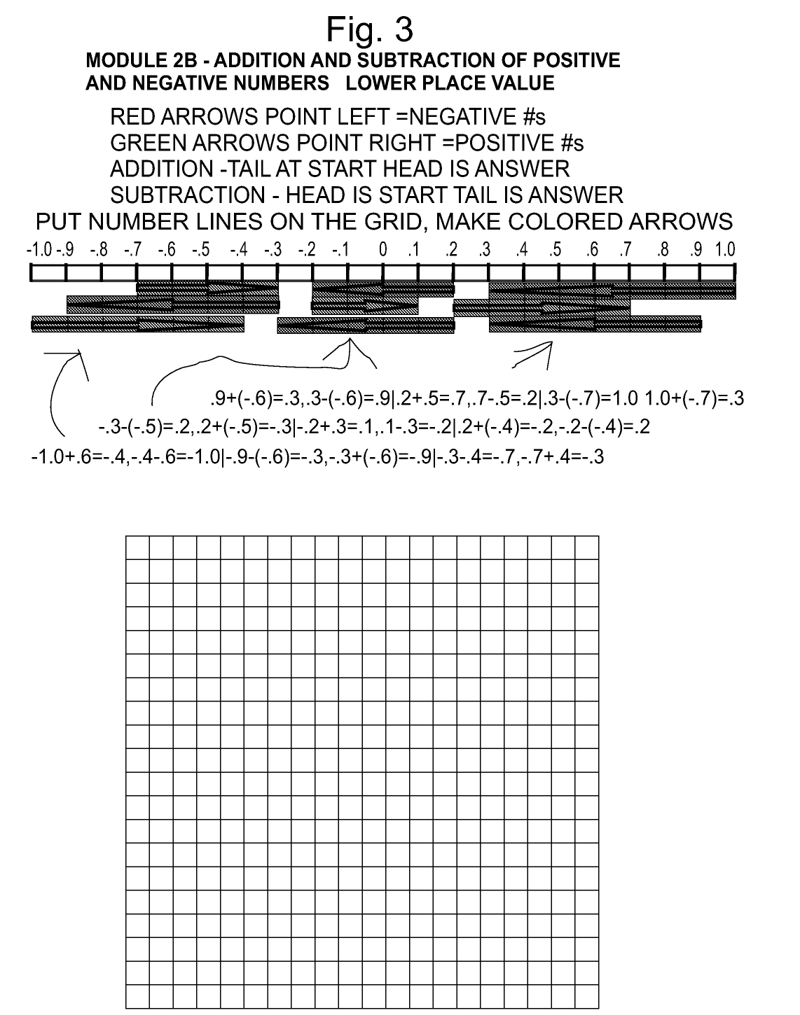

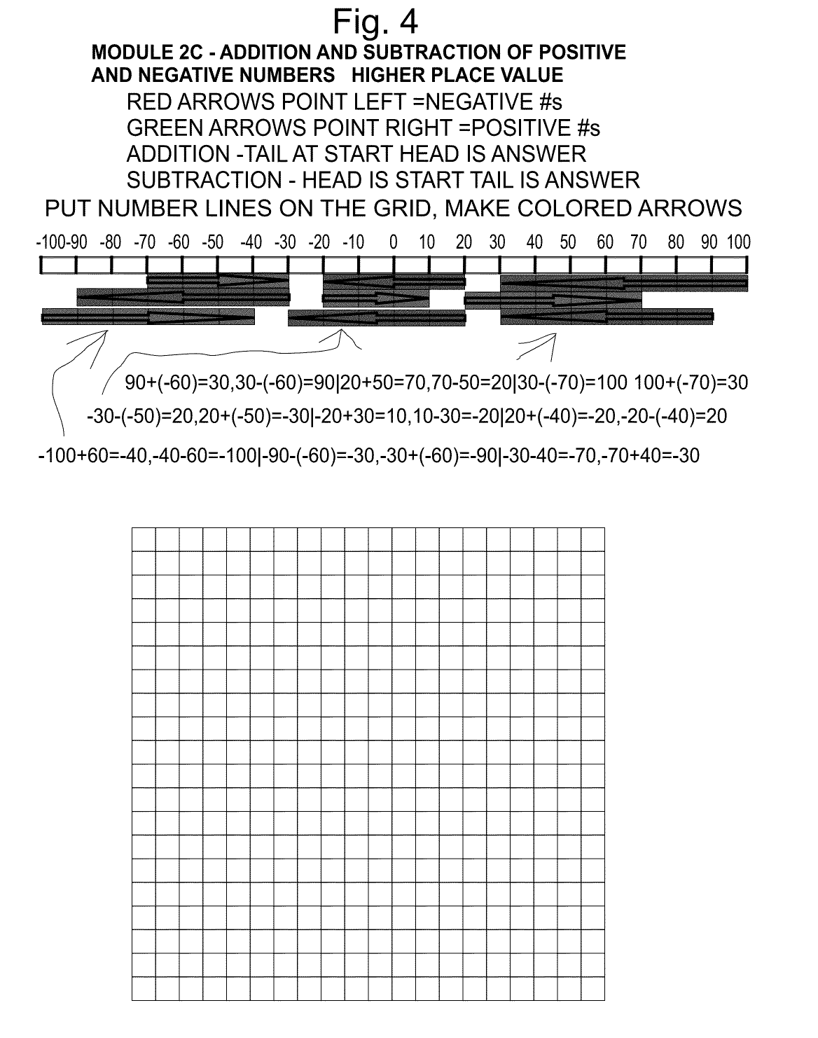

### Module 2B—Addition and Subtraction of Positive and Negative Numbers—Lower Place Value (FIG. 3)

Use a combination of a number line centered on zero, and color coded directional arrows of varying magnitude. Positive quantities are always green arrows pointing right. Negative quantities are always red arrows pointing left. The arrows have gradations equal to the scale on the number line, and the number line has 0.0 on all numbers. Call it the number's tail when a kid asks, and tell them to not worry about it. Tell them we will lengthen the tail in the future. They need to see that place. To add we always place the arrow tail on the starting point and “Tape” the arrow down on the number line like taping with actual scotch tape. Do this in a fashion to give a sense of adding unit by unit ending at the answer. It is like filling a glass with water. The child gets a mechanical sense of addition that way. They see that adding a positive quantity moves you to the right, and adding a negative quantity moves you to the left on the number line. Subtraction is the opposite. You place the arrow head on the starting point. You allow the entire arrow to be on the number line, answer revealed at the tail. However, at that starting point you peel the arrow off the number line (like peeling off tape) in the direction of the tail and the student gets the mechanical sense of subtraction as they remove, take away, or “subtract” the arrow. They visually see that subtraction of a positive quantity moves you leftward on the number line as common sense tells you, but they also get a mechanical and visual representation of how subtraction of a negative quantity moves you rightward on the number line and increases your quantity. A concept that is hard for both children and adults to visualize and internalize. Remember: when you add a negative number you subtract and when you subtract a negative number you add! Give your student problems and have them use color coded directional arrows for solutions. Interject time (5 on Monday, 7 on Wednesday. etc.) Your student can also make labeled arrows from the bottom 8 number lines and also color the lines during their exploration. At first they will think they are doing module 2A again. Let them be comfortable doing the same thing they did in module 2A with this module. Let them give and write solutions with whole numbers. Let them do this for multiple and many sessions with this module. Have your student write standard equations for the activities that they do with this module. It is very important for them to keep and/or save ALL of the activities that they do. At the appropriate time, have your students pull out all their old work and have them put a decimal point with a following zero on their recorded answers. Then show them how to move the decimal place over to the left by one place. You have already shown them that the mechanics of addition and subtraction are the same as with whole numbers.

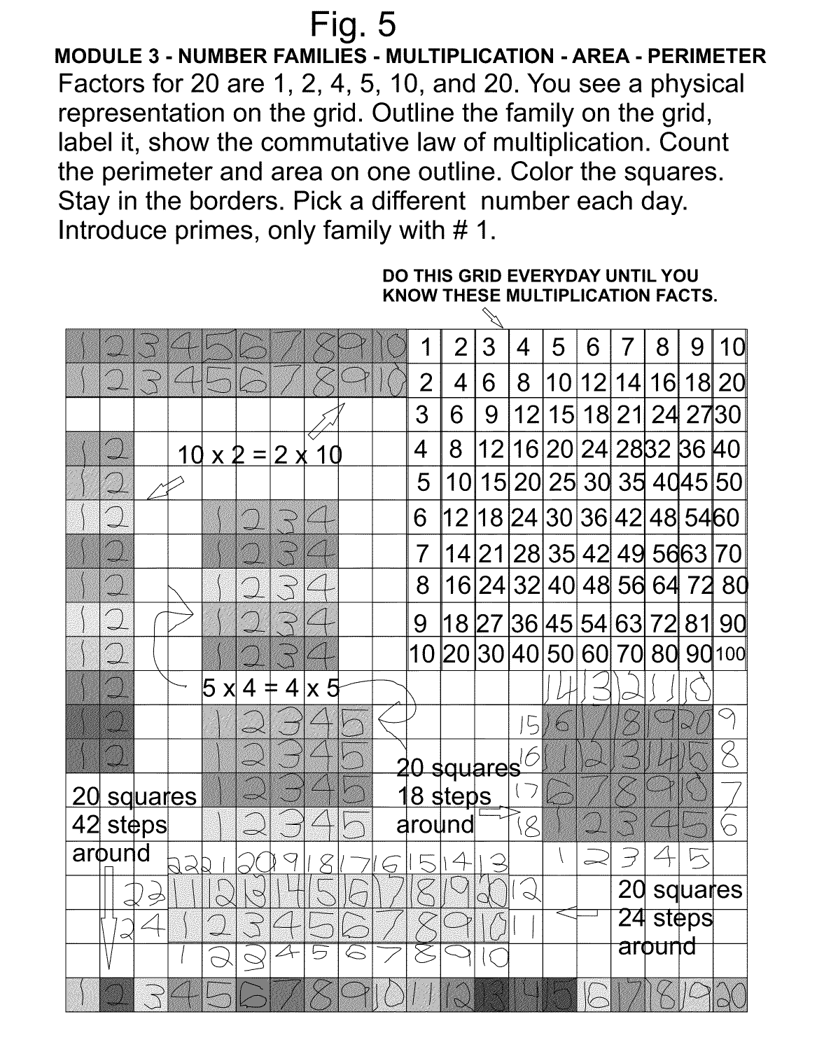

### Module 2C—Addition and Subtraction of Positive and Negative Numbers—Higher Place Value (FIG. 4)

Use a combination of a number line centered on zero, and color coded directional arrows of varying magnitude. Positive quantities are always green arrows pointing right. Negative quantities are always red arrows pointing left. The arrows have gradations equal to the scale on the number line, and the number line has 0.0 on all numbers. Call it the number's tail when a kid asks, and tell them to not worry about it. Tell them we will lengthen the tail in the future. They need to see that place. To add we always place the arrow tail on the starting point and “Tape” the arrow down on the number line like taping with actual scotch tape. in a fashion to give a sense of adding unit by unit ending at the answer. It is like filling a glass with water. The child gets a mechanical sense of addition that way. They see that adding a positive quantity moves you to the right, and adding a negative quantity moves you to the left on the number line. Subtraction is the opposite. You place the arrow head on the starting point. You allow the entire arrow to be on the number line, answer revealed at the tail. However, at that starting point you peel the arrow off the number line (like peeling off tape) in the direction of the tail and the student gets the mechanical sense of subtraction as they remove, take away, or “subtract” the arrow. They visually see that subtraction of a positive quantity moves you leftward on the number line as common sense tells you, but they also get a mechanical and visual representation of how subtraction of a negative quantity moves you rightward on the number line and increases your quantity. A concept that is hard for both children and adults to visualize and internalize. Remember: when you add a negative number you subtract and when you subtract a negative number you add! Give your student problems and have them use color coded directional arrows for solutions. Interject time (5 on Monday, 7 on Wednesday. etc.) Your student can also make labeled arrows from the bottom 8 number lines and also color the lines during their exploration.

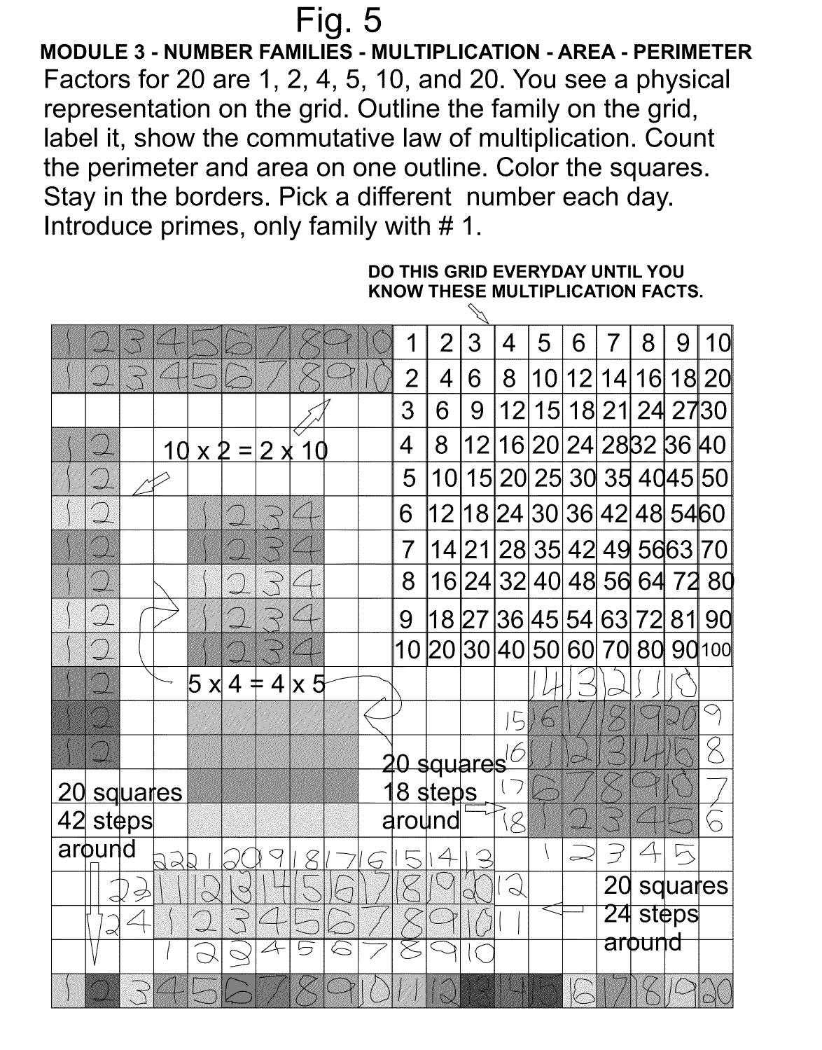

### Module Three—Number Families—Multiplication—Area—Perimeter (FIG. 5)

Early in your child's quest to 100, start the number family module. Start right away at 1=1×1, 2=1×2=2×1, 3=1×3=3×1, and 4=1×4=4×1=2×2. Start Mod 3 in the first row of Mod 1. Below is the example with the number 20. Find all the ways to make it on the checkerboard/grid. The number 20 can be represented by 1×20, 2×10, 10×2, 5×4 or 4×5. Your student will see a physical representation on the empty checkerboard/grid. Have your student outline the family on the grid and label all families as shown in the example. This will demonstrate the commutative law of multiplication. Have your student count and label the perimeter and area. Have your student color the squares, Have your student stay in the borders. Pick a different number each day. Introduce primes, such as 13, only family with #1. Do this for all the numbers they reach. Start this module early. You can start showing your student the number family before they are filling in module 1. Outline, label, and color for your child as a demonstration of how to use the module. When your child begins this module allow self-assistance. That will lead to incorporation of many multiplication facts. Prime numbers cannot form a rectangle with at least 2 sides with length 2 or more on the grid. Let your student demonstrate that fact. Have your student fill out the 10×10 grid with the multiplication facts 2-3×/week. Cover the answer key after a few completions. Have your student explore every number as they reach them in module 1. Coloring is always important.

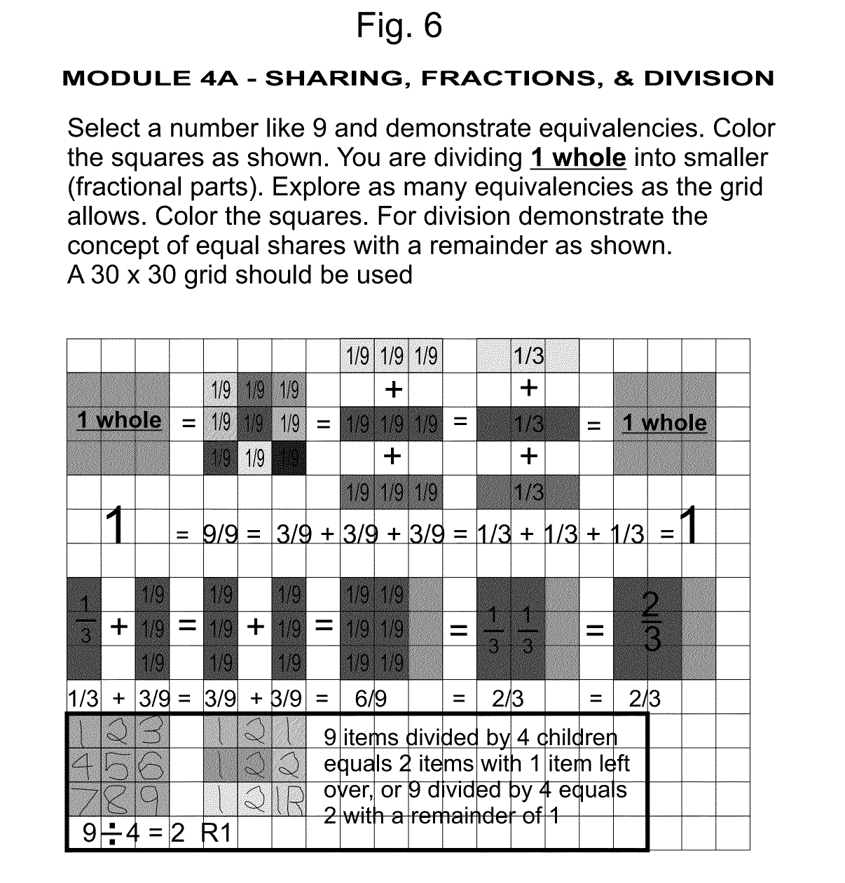

### Module 4A—Sharing, Fractions, and Division (FIG. 6)

It is very important to start the sharing activities as soon as your child understands “sharing.” Coloring the tasks is critical to solidifying the physical or real world meaning of fractions. Coloring is fun and an attraction to your students. It is also a critical component of the learning process. Do not minimize coloring's value, and insist on coloring as a requirement for completion of all tasks or explorations with the grid. The sharing activities have given your student the foundation for fractions and division. Demonstrate both on the checkerboard grid. Select a number like 9 and demonstrate equivalencies. Have your student color the squares as shown. Emphasize that you are dividing 1 whole into smaller (fractional parts). Have your student explore on their own, as many equivalencies as the grid allows. The number family module has given your student a foundation for self-assistance in this module. OVER TIME your student will clearly see that equivalencies are easily formed within number families! Your student will discover the rule sets thru self-assistance. IT IS VERY IMPORTANT TO COLOR THE SQUARES!!! For division coloring the squares as shown will demonstrate the concept of equal shares with a remainder. There are lots of combinations to choose from for both fraction equivalencies and division!!! To maintain uniformity, go thru the numbers used in the number family exercises. You will be surprised how synergistic these two modules will be and how fast your child will master them. Demonstrate Least Common Denominator use with easy combinations at first. ½+¼=¾ would be a good place to start. As the “Capable Expert” (teacher) use your imagination and create activities that allow self-assistance and self-discovery of the rule set, without your assistance. Remember, if your student has been using checkerboard math for a while, they are probably ahead in math. OVER TIME they will master fractions using this researched method.

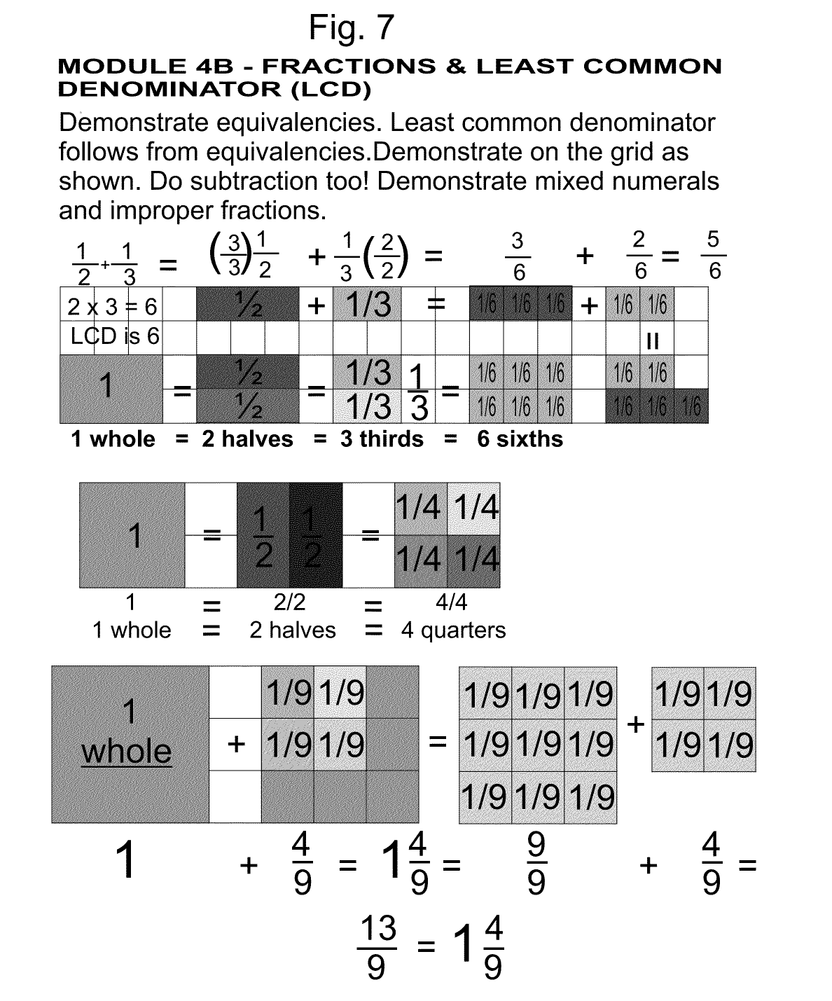

### Module 4B—Fractions and Least Common Denominator (LCD) (FIG. 7)

It is very important to start the sharing activities as soon as your child understands “sharing.” Coloring the tasks is critical to solidifying the physical or real world meaning of fractions. Coloring is fun and an attraction to your students. It is also a critical component of the learning process. Do not minimize coloring's value, and insist on coloring as a requirement for completion of all tasks or explorations with the grid. The sharing activities have given your student the foundation for fractions. Demonstrate on the checkerboard grid. Select a number like 9 and demonstrate equivalencies. Have your student color the squares as shown. Emphasize that you are dividing 1 whole into smaller (fractional parts). Have your student explore on their own as many equivalencies as the grid allows. The number family module has given your student a foundation for self-assistance in this module. OVER TIME your student will clearly see that equivalencies are easily formed within number families! It is very important to color the squares. Least common denominator follows from equivalencies. Demonstrate on the grid as shown. Show your student that a common denominator can always be found by multiplying the denominators of the fractions. However it is not always the LEAST common denominator as seen in the example of ⅓+ 3/9. Help your student understand that you are multiplying by 1 in the form of (3/3) and (2/2) as shown in the example of ½+⅓. Demonstrate mixed numerals and improper fractions. There are lots of combinations to choose from!! ALWAYS COLOR ACCURATELY. Do subtraction exercises as well! Try ¼-⅕. Your student will remember 20 from the number family module!

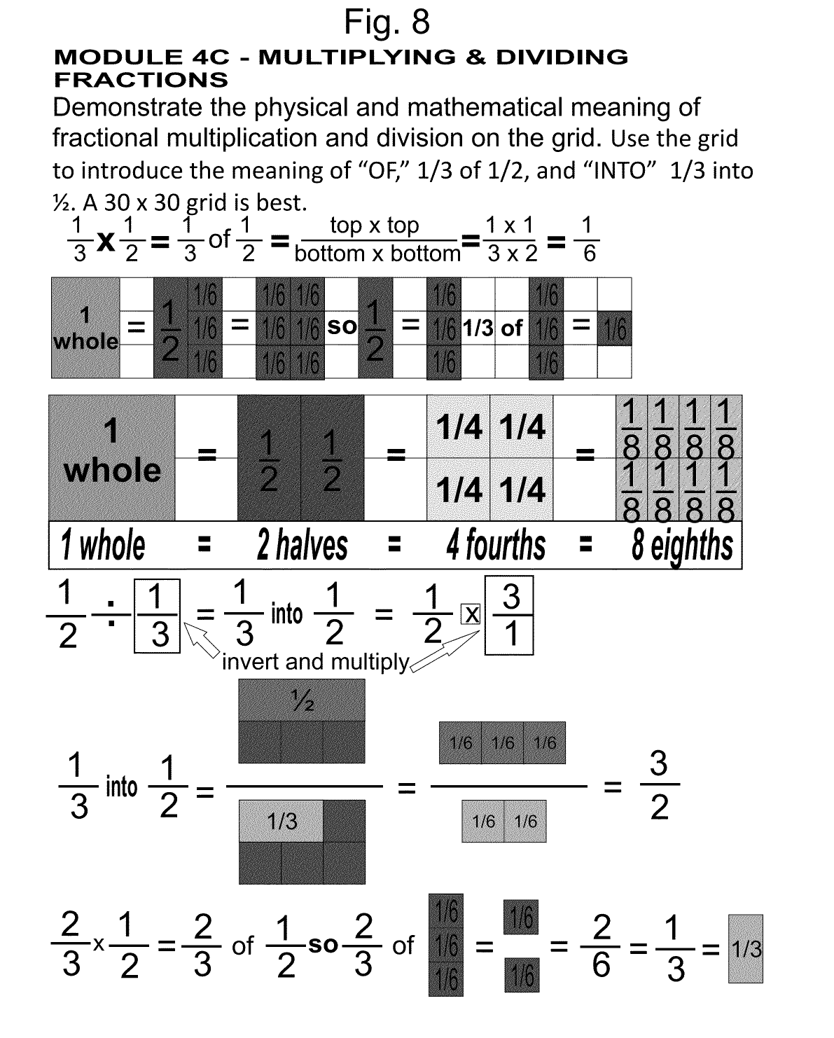

### Module 4C—Multiplying and Dividing Fractions (FIG. 8)

It is very important to start the sharing activities as soon as your child understands “sharing.” Use This module to solidify the concepts of fractional equivalencies, LCD, and mixed numeral/improper fraction conversions. Coloring the tasks is critical to solidifying the physical or real world meaning of fractions. Coloring is fun and an attraction to your students. It is also a critical component of the learning process. Do not minimize coloring's value, and insist on coloring as a requirement for completion of all tasks or explorations with the grid. The examples of multiplication and division are for demonstration of how this model can show your students the physical and mathematical meaning of fractional multiplication and division. The rule set is simple. Multiply numerator×numerator and denominator×denominator for multiplication, and invert and multiply for division. Multiplying and Dividing Fractions should be done with pencil on paper. Not the grid. To help your student conceptualize, introduce the meaning of “OF.” ⅓ of ¼, ⅕ of ¼, etc. Reinforce the concept of “into” to help conceptualize fractional division and division in general. Use the grid to help solidify the model, as shown in the examples.

### Sharing:

Sharing is an ancillary activity to prepare your student early on for CB Math. As soon as your child can understand the concept of sharing (one year or so) start the sharing activity. This is an activity that I call the karate kid effect. This is an activity that your child will look forward to participating in, and will teach them about fractions without them really knowing that they're being taught. Sort of like paint the fence and wax on wax off from the karate kid movie. There are two types of sharing activities. Dividing single items like candy bars to share among multiple people, and dividing multiple items such as jellybeans equally among several people.

The simplest fraction concept for a child to grasp is dividing a single item in half to share among two people. You and your child can begin the sharing activity now. Your child will quickly grasp that sharing a single item among three people is a little more difficult than sharing among two. Sharing a single item among four people is something that your child again will easily grasp as you show them how to divide in half and then how to divide those halves in half. Once again your child will easily grasp the difficulty of sharing among five people. Try to find an opportunity to take your child to sharing among six people. You will first divide that single item in half, and then divide those halves into three. You will be demonstrating a combination of both an easy and hard step. Let your child discover on their own the difficulty of sharing among seven. In all the activities that I will describe it is important to allow your child to make their own discoveries. Do not rush this process. Checkerboard math, to be truly successful, is a many year process. The sharing activity is something that can be initiated very early in your child's life, and if it took two years or more for your child to reach their own discovery of the difficulty of sharing among seven people, we have won the war.

The second sharing activity, dividing multiple items among multiple people will teach your child fractions, and the model for division will be created by the karate kid effect. Find an opportunity to share jellybeans or other multiple unit things amongst your children or your child and their friends. Have them gather around in a circle to watch you share or “divide” the items. Divide them by going around the circle distributing one item to each person until you don't have enough to complete another trip around the circle. If there are three children and seven items, at the end of the second revolution you would have distributed two items per child. At that point that last item shall not be distributed and will be called the remainder or left over. At that point you the parent shall declare that seven items divided by three children is equal to two with a remainder or left over of one. And that one is for mommy, or daddy, or whoever. Over the years, given all the different combinations of sharing activities for multiple items and multiple people, your child will have a solid model of division.

It is important to make the sharing activities a big deal. As children are easily led, the sharing activities can be made important in your child's mind. Not only will your child develop models for fractions and division, they will develop good citizenship. The name of the activity “Sharing” will teach them a fundamental good character trait. Once again, do not rush this process. Your child will pick these concepts up at his or her own pace. Allow it to be a fun and natural process. At a certain point have your child or student lead the sharing activity.

### BREADTH OF INVENTION AND RAMIFICATIONS

While the above description contains many specificities, these should not be construed as limitations on the scope of the invention, but merely as an example of the presently-preferred embodiment thereof. Many variations of the invention are possible. For example the size of the grid may vary based on the magnitude of the numbers used. The size of the grid would vary accordingly. The size of the device overall can be varied from large physical or projected displays, suitable for the front of the classroom, to more compact versions feasible for both home and school use. This instructional tool lends itself to computer representation as well, where exploration of math concepts can be explored via a “mouse”, or otherwise directed via keyboard or hand-held input device, or via a touch function as found on touch pad devices like the Ipad or other tablet like devices. It lends itself to hand held and other electronic devices as well. It will be apparent to those skilled in the art that the disclosed mathematical teaching aid may be modified in numerous other ways and may assume many embodiments other than the preferred form specifically set out and described above. Accordingly, it is intended by the appended claims to cover all such modifications of the invention which fall within the true spirit and scope of the invention as well as all future embodiments created by inventor. Accordingly, the full scope of the invention should be determined, not by the examples given, but by the appended claims and their legal equivalents. It is not desired to limit the invention to the exact construction and operation shown and described, and accordingly, all suitable modifications and equivalents may be resorted to, falling within the scope of the invention. For example, various other known configurations of electronic circuitry and components to accomplish the functions described herein are possible and within the scope of the present invention. The present invention may, of course, be carried out in other specific ways (known or unknown) than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein. Therefore, the foregoing is considered as illustrative only of the principles of the invention. Further, since numerous modifications and changes will readily occur to those skilled in the art, it is not desired to limit the invention to the exact construction and operation shown and described.

What I claim as my invention and as being new and desired to be protected by Letters Patent of the United States is:

1. Checkerboard Math/Dora's Grid Math, a mathematical teaching tool comprising; modules that are separate or combined, that are various size, that are various material, and are utilized in various modes of manual/media/computer/electronic or other presentation, that are based on a background grid that is either a blank grid matrix or checkerboard patterned grid matrix of N×M size where N and M are whole numbers greater than 1; said mathematical teaching tool further comprises attached instructions for use, and attached examples of use, as well as separate or combined unattached instructions for use and unattached examples of use, to be read and implemented by the capable expert (teacher), and also attached are examples of mathematical concepts meant to demonstrate the types of self-discovery and self-assistance games to be played by the user (student) on or with the Grid/Checkerboard pattern, where the user of said mathematics teaching tool observes the tool and/or uses various manual, body part, or electronic input writing and/or coloring instruments to complete tasks and play math learning games that teach mathematics concepts from the preK to the college level by using a grid based math model that uses observation, symbolism (color, numerals, objects), calculation (counting squares, counting objects, counting other symbols), and writing (recording numerals, objects, and symbols and coloring objects and symbols) to stimulate the use of, and exploit the power of the brain's left sided math center and thereby teach math.

2. The mathematical teaching tool of claim 1 consisting of a 10×10 Checkerboard matrix, with attached instructions for use, and attached examples of use, as well as unattached instructions for use and unattached examples of use, called Module 1 Counting 1 to 100.

3. The mathematical teaching tool of claim 1 consisting of a 20×20 Plain grid matrix, with labeled number lines on the grid, with attached instructions for use, and attached examples of use, as well as unattached instructions for use and e unattached examples of use, called Module 2A—Addition and Subtraction of Positive and Negative Numbers.

4. The mathematical teaching tool of claim 1 consisting of a 20×20 Plain grid matrix, with labeled number lines on the grid, with attached instructions for use, and attached examples of use, as well as unattached instructions for use and unattached examples of use, called Module 2B—Addition and Subtraction of Positive and Negative Numbers lower place value.

5. The mathematical teaching tool of claim 1 consisting of a 20×20 Plain grid matrix, with labeled number lines on the grid, with attached instructions for use, and attached examples of use, as well as unattached instructions for use and unattached examples of use, called Module 2C—Addition and Subtraction of Positive and Negative Numbers higher place value.

6. The mathematical teaching tool of claim 1 consisting of a 20×20 Plain grid matrix, with attached instructions for use, and attached examples of use, as well as unattached instructions for use and unattached examples of use, called Module 3—Number Families—Multiplication—Area—Perimeter.

7. The mathematical teaching tool of claim 1 consisting of a 30×30 Plain grid matrix, with attached instructions for use, and attached examples of use, as well as unattached instructions for use and unattached examples of use, called Module 4A—Sharing, Fractions, and Division.

8. The mathematical teaching tool of claim 1 consisting of a 30×30 Plain grid matrix, with attached instructions for use, and attached examples of use, as well as unattached instructions for use and unattached examples of use, called Module 4B—Fractions and Least Common Denominator (LCD).

9. The mathematical teaching tool of claim 1 consisting of a 30×30 Plain grid matrix, with attached instructions for use, and attached examples of use, as well as unattached instructions for use and unattached examples of use, called Module 4C—Multiplying and Dividing Fractions.
